(19) United States
(12) Patent Application Publication
(10) Pub. No.: US 2003/0113519 A1
(43) Pub. Date: Jun. 19, 2003

(54) Synthetic based self seal adhesive system for packaging

(75) Inventors: Charles J. Wasserman, New Berlin, WI (US); Harold G. Story, Milwaukee, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Ato Findley, Inc., Waunatosa, WI

(21) Appl. No.: 10/254,695

(22) Filed: Sep. 25, 2002

Related U.S. Application Data
(63) Continuation of application No. 09/099,177, filed on Jun. 18, 1998, now abandoned.

(51) Int. Cl. B32B 33/00

(52) U.S. Cl. 428/195; 428/40.1; 428/41.8

(57) ABSTRACT

The present invention provides a waterbase self seal adhesive system utilizing a self seal adhesive containing no natural rubber. The self seal adhesive system is comprised of a transfer (front) adhesive disposed on a transfer (front) web and an anchor (back) adhesive disposed on an anchor (back) web with the two adhesives forming the seal for the package. The self seal adhesives bond to themselves when pressure is applied to close or seal the packaging material. In one embodiment, when peeled apart, the adhesive transfers from one substrate of the package to the other substrate of the package to enable opening of the package and thereafter prevents resealing of the package. In another embodiment, when peeled apart, the adhesive splits, adhesively fails from either or both the front web or the back web, or destroys one or both of the substrates of the package. In either embodiment, primers and release coatings may also be used to enhance performance of the self seal adhesive.

### BACKGROUND OF THE INVENTION

The present invention relates to waterbase self seal adhesive packaging systems, and more particularly to a waterbase self seal adhesive flexible packaging system that: 1) utilizes a synthetic-based, self seal adhesive containing no natural latex that provides a bond between two substrates when sealed, but when peeled, the adhesive transfers from one substrate to the other, thus preventing resealing of the packaging; or 2) utilizes a synthetic-based, self seal adhesive containing no natural latex that provides a bond between two substrates when sealed, but when peeled, the adhesive splits, adhesively fails from either or both the front web or the back web, or destroys one or both of the substrates of the package. Primers and release coatings may also be used to enhance the performance of the self seal adhesive.

A self seal adhesive is a type of pressure-sensitive adhesive, which possesses the ability to form a strong bond to itself when pressure is applied and form a bond to the substrate on which it is applied. However, self seal adhesives preferably lack adhesion to surfaces such as plastic films and overprint varnishes which are on the opposite face of these flexible substrates so that such flexible substrates or webs bearing the self seal adhesives may be reeled into a roll for storage without blocking, i.e. without sticking together. Self seal adhesives are used in a variety of different types of applications, but are particularly desirable for use as sealants in packaging for food such as candies, chocolates, ice cream and the like which are sensitive to heat thus rendering undesirable the use of heat sealable adhesives to seal such packages. Another desirable application is in packaging medical products. Many medical devices are contained within paper packages and the adhesive used must provide a strong seal to maintain sterility, but when opened must be non-resealable. In addition, adhesives having high blocking or sticking properties are undesirable in such applications since contamination from paper fibers and/or shreds during opening may result in serious consequences.

Typical self seal adhesives have been formulated by combining a natural rubber elastomer, particularly a latex, with a tackifier and other ingredients such as stabilizers, antioxidants, etc. Natural rubber elastomers exhibit most of the desirable self sealing properties. However, natural rubber-based adhesives also exhibit poor aging properties such as discoloration, and may also possess objectionable odor. In addition, natural rubber-based adhesives containing natural latex have a variety of naturally occurring substances such as plant proteins which can cause allergic reactions in people.

A number of attempts have been made to develop a synthetic self seal, i.e. one that does not contain any natural latex. These approaches vary in the chemistry used. For example:

U.S. Pat. No. 4,810,745, assigned to Century Adhesives Corp. describes both a natural latex based self seal and one comprised of a styrenic block copolymer emulsion (25 to 45%), an acrylic polymer (20 to 25%), a tackifier (25 to 35%), and vinylpyrolidone/styrene copolymer.

U.S. Pat. No. 4,889,884, assigned to National Starch and Chemical Corp. describes a formulation comprised of four synthetic polymers, i.e. the first comprised of butyl acrylate, 2-ethyl hexyl acrylate, and vinyl acetate (T_{g}=54° C., Williams Plasticity of 2.7), the second comprised of medium styrene content acrylic resin (T_{g}=−18° C., Williams Plasticity of 5.1), a third comprised of butyl acrylate, vinyl acetate, acrylic acid, and N-methylolacrylamide (T_{g}=−2° C., Williams Plasticity of 5.3), and a fourth comprised of a high styrene acrylic resin (T_{g}=+6° C.). As alternatives for the fourth resin the following could be used: medium styrene content acrylic resin, a low ethylene vinyl acetate resin, a medium ethylene vinyl acetate resin, or a vinyl acrylic resin containing acid and N-methylolacrylamide.

U.S. Pat. No. 4,898,787, assigned to National Starch and Chemical Corp., describes a formulation comprised of two synthetic polymer emulsions. The primary synthetic emulsion (45 to 70% of the formulation), has a T_{g} of −60° C. to −40° C. and a Williams Plasticity Number of 2.5 to 2.9, and a secondary styrene acrylic emulsion (30 to 55% of the formulation), has a T_{g} of −25° C. to +5° C., and a Williams Plasticity Number of 5.0 to 5.6.

U.S. Pat. No. 5,070,164, assigned to Mobil Oil Corp., describes an-acrylic copolymer comprised of the first monomer selected from the group of ethyl acrylate, hexyl acrylate, isoctyl acrylate, butyl acrylate, methyl acrylate and vinylidene chloride, a second monomer selected from the group of vinyl acetate, methyl methacrylate, styrene, ethyl methacrylate, and isobutyl methacrylate and a third monomer selected from the group of methacrylic acid, acrylic acid, itaconic acid, sulfoethyl methacrylate, and malic acid with an additional condition, that each of the first, second and third monomers are different.

U.S. Pat. No. 5,486,426, assigned to Mobil Oil Corp., describes an acrylic copolymer composition, polymerized using an acrylonitrile from 10 to 65%, a soft monomer (acrylate esters from methyl to isooctyl or vinyl acetate) from 30 to 85%, and an acid third monomer (methacrylic acid, acrylic acid, crotonic, itaconic acid, sulfoethyl methacrylate, and maleic acid) from 1 to 3%, such that the resulting polymer has a T_{g} of −35° C.

Ato Findley product, C1301-01, is a synthetic self seal comprised of an elastomeric copolymer emulsion, and modifiers.

The above attempts to replace natural rubber with synthetic adhesives to alleviate these problems has proven to be difficult because of the poor performance of the resultant bonds. Accordingly, there remains a need for an improved self seal adhesive system containing no natural rubber which exhibits the desired attributes noted above.

### SUMMARY OF THE INVENTION

The present invention relates to waterbase self seal adhesive packaging systems, and more particularly to a waterbase self seal adhesive flexible packaging system that: 1) utilizes a synthetic-based, self seal adhesive containing no natural latex that provides a bond between two substrates when sealed, but when peeled, the adhesive transfers from one substrate to the other, thus preventing resealing of the package, called a Peelable Non-Resealable (PNR); or 2) utilizes a synthetic-based, self seal adhesive containing no natural latex that provides a bond between two substrates when sealed, but when peeled, the adhesive splits, adhesively fails from either or both the front web or the back web, or destroys one or both of the substrates of the package, called a Peelable. Primers and release coating may also be used to enhance the performance of the self seal adhesive.

For the PNR system, after sealing, it is essential that the transfer adhesive has more affinity for the anchor adhesive than it does for the substrate of the transfer web. It is also essential that the transfer adhesive does not destroy, pull paper fibers or delaminate the transfer web substrate. Thus, it is essential that the anchor adhesive has more affinity for the anchor web and for the transfer adhesive than the transfer adhesive has for the substrate of the transfer web. This is measured by percent transfer of the transfer adhesive to the anchor adhesive when peeling in a T-peel configuration. A transfer adhesive when peeled must not be resealable to the transfer web. The preferred transfer substrate is, but not limited to, bleached kraft paper which is typically used in packaging sterilizable medical devices. The preferred anchor substrate is, but not limited to, a polyolefin film.

Accordingly, in order to accomplish the above, the present invention provides a flexible substrate anchor web having an exterior surface and an interior surface, a flexible substrate transfer web having an exterior surface and an interior surface with the interior surface adapted to combine with the interior surface of the anchor web to form a package to contain an article. The self seal adhesive system utilized with such a package includes a non-natural rubber containing anchor adhesive applied over a first area of the interior surface of the anchor web, a non-natural rubber-containing transfer adhesive applied over a second area of the interior surface of the transfer web so that the first and second areas are disposed in registry when the anchor and transfer webs combine to form the package. The transfer adhesive has more affinity for the anchor adhesive than for the transfer web, and the anchor adhesive has for affinity for the anchor web and for the transfer adhesive than the transfer adhesive has for the transfer web. When the anchor web and transfer web are combined, the first and second areas align and the anchor adhesive and transfer adhesive bond to one another to form a seal for the package. The bond formed thereby is stronger than the bond between the transfer adhesive and the transfer web resulting in the transfer of the transfer adhesive onto the anchor adhesive when the anchor web and the transfer web are peeled apart, and thereby providing a non-resealable package.

The transfer and anchor adhesives are formulated to contain no natural rubber, but instead contain an elastomer selected from the group consisting of: styrene-isoprene-styrene, styrene-butadiene-styrene, styrene-ethylene-butylene-styrene, ethylene-vinyl-acetate, amorphous polyalpha-olefin, styrene-butadiene-rubber, butyl, polychloroprene and synthetic polyisoprene. The elastomer is formulated with various compatible tackifying resins, antioxidants, inert fillers and conditioning additives. The preferred elastomer is styrene-isoprene-styrene and the preferred tackifying resin is a modified rosin ester.

An anchor primer coating on the interior surface of the anchor web may also be utilized to enhance adhesion of the anchor adhesive to the anchor web. If utilized, the anchor primer coating comprises about 2 to 99.9% by weight of a polymer or combination of polymers, selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers. The rest of the composition to be comprised of modifiers and water. Also, a transfer primer coating may be utilized on the interior surface of the transfer web to decrease adhesion of the transfer adhesive to the transfer web. If utilized, the transfer primer coating comprises about 2 5 to 99% by weight of a polymer selected from: a high molecular weight polyethylene polymer or ethylene copolymer, SIS, SBS, SEBS, SBR, acrylics, silicone, or any other polymer base that can provide release from the transfer web.

In one embodiment, the anchor adhesive and transfer adhesive have different formulations, and the anchor web and transfer web are separate substrates, each composed of different materials. In another embodiment, the anchor adhesive and transfer adhesive have different formulations, but the anchor web and transfer web are both part of the same substrate and composed of the same material. In a third embodiment, the anchor adhesive and transfer adhesive have substantially the same formulation, but the anchor web and transfer web are composed of different materials. In a fourth embodiment, the anchor adhesive and the transfer adhesive have essentially the same formulation, but the transfer and anchor primers are different compositions, with the anchor and transfer webs being either the same or different materials.

In the Peelable system, after sealing, it is essential that the transfer front web adhesive has a balanced affinity between the anchor (back) adhesive and the substrate of the transfer (front) web. In many end uses, the terms front and back are substituted for transfer and anchor respectively. It is also essential that the anchor (back) adhesive has a balanced affinity between the transfer (front) adhesive and the substrate of the anchor (back) web. This is measured by the peel strength of the adhesive, and its failure mode, when peeling in a T-peel configuration. To those skilled in the art, types of failure modes are, but not limited to: cohesive failure, cohesive split, adhesive split, adhesive failure to one substrate or the other (clean peel), etc. The preferred transfer (front) or anchor (back) substrate is, but not limited to, polyolefin or metallized polyolefin films.

The transfer (front) and anchor (back) adhesives are formulated to contain to no natural rubber, but instead contain an elastomer selected from: styrene-isoprene-styrene, styrene-butadiene-styrene, styrene-ethylene-butylene-styrene, ethylene-vinylacetate, amorphous polyalpha-olefin, styrene-butadiene rubber, acrylics, acrylic copolymers, epdms, butyl, polybutadienes, polychloroprene, silicones, synthetic polyisoprene and/or combinations of these elastomers. The elastomer is formulated with various other polymers, plasticizers, pH adjusters antiblocking/anticling additives, defoamers and other additives. The preferred elastomers are styrene-butadiene rubber and acrylic and the preferred polymer is a styrene acrylate.

An anchor (back) primer on the interior surface of the anchor (back) web may also be utilized to enhance adhesion of the anchor (back) adhesive to the anchor (back) web. If utilized, the anchor (back) primer coating comprises about 2 to 99.9% by weight of a polymer or combination of polymers selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers. The rest of the composition to be comprised of modifiers and water. Also, a transfer (front) primer coating may be utilized on the interior surface of the transfer (front) web to decrease adhesion of the transfer (front) adhesive to the transfer (front) web. If utilized, the transfer (front) primer coating comprises about 5 to 99% by weight of a polymer selected from: a high molecular weight polyethylene polymer or ethylene copolymer, SIS, SBS, SEBS, SBR, acrylics, silicone, or any other polymer base that, when formulated with the appropriate ingredients, can provide release from the transfer web.

In one embodiment, the anchor (back) adhesive and transfer (front) adhesive have different formulations, and the anchor (back) and transfer (front) webs are separate substrates, each composed of different materials. In another embodiment, the anchor (back) and the transfer (front) adhesive have different formulations, but the anchor (back) and transfer (front) web are both part of the same substrate and composed of the same material. In a third embodiment, the anchor (back) and the transfer (front) adhesives have substantially the same formulation, but the anchor (back) and the transfer (front) web are composed of different materials. In a fourth embodiment, the anchor adhesive and the transfer adhesive have essentially the same formulation, but the transfer and anchor primers are different compositions, with the anchor and transfer webs being either the same or different materials. In a fifth embodiment, the anchor adhesive and the transfer adhesive have essentially the same formulation, but the anchor (back) and transfer (front) web are both part of the same substrate and composed of the same material.

### DETAILED DESCRIPTION OF THE INVENTION

The present invention relates to waterbase self seal adhesive packaging systems, and more particularly to a waterbed self seal adhesive flexible packaging system that: 1) utilizes a synthetic-based, self seal adhesive containing no natural latex that provides a bond between two substrates when sealed, but when peeled, the adhesive transfers from one substrate to the other, thus preventing resealing of the package, called a Peelable Non-Resealable (PNR); or 2) utilizes a synthetic-based, self seal adhesive containing no natural latex that provides a bond between two substrates when sealed, but when peeled, the adhesive splits, adhesively fails from either or both the front web or the back web, or destroys one or both of the substrates of the package, called a Peelable. Primers and release coating may also be used to enhance the performance of the self seal adhesive. The packaging material can be utilized to wrap various types of products, such as food products like candy and other comestibles, or sterile medical devices such as syringes, tubing, gloves, bandages and the like. Although food products and medical devices may be the preferred articles wrapped by the present self seal adhesive system, the present disclosure is not limited to such packages, but instead may be utilized with other forms of packaging for containing both comestible as well as non-comestible products.

The creation of a package typically begins with the production of a continuous sheet or web of wrapping material. The continuous web of material is generally in the form of a thin, flexible film, and as is conventional, proceeds generally horizontally downstream to multi-station printing presses where artwork and text in one or more colors is applied to its exterior surface, and adhesive in applied to its interior surface in either a predetermined pattern or overall coverage. The adhesive pattern typically will be rectangular defined by a pair of longitudinal strips along opposite edges of the web and a transverse strip extending between the two longitudinal strips. The distance between the transverse strips of adhesive define the length of the particular wrapper. The adhesive layer is typically applied to the interior surface of the web after the application of the artwork and text on the exterior of the web by Gravure roll application, or by any other conventional means, so that the layer of adhesive has a thickness of about 0.05 to about 1.0 mil and may consist of either a multitude of separate spots or dots or a solid continuous layer. Also, it is typical for a protective surface, such as an overprint varnish or a release film, to be applied over the artwork and text to protect the artwork and text from smudging, and to increase the coefficient of friction of the exterior surface of the web. As is conventional, the adhesive is applied in lengthwise and widthwise strips in the appropriate surface areas of the web to form a rectangular configuration so that after insertion of the article to be wrapped, the web may be folded so that the longitudinal and transverse strips of adhesive register with one another and become aligned so that upon the application of pressure, the web forms the shape, size and volume with the package desired.

As noted above, the web itself is generally preferred to be formed as a thin, flexible material to function as a substrate for the materials to be applied. The web itself may be made of a plastic film material such as polyethylene, polypropylene, polyesters, polyolefins, polystyrene, nylon, polycarbonates, cellophane, ethylenevinyl acetates, ethylenevinyl alcohols, polyvinyl alcohols, polyvinyl chloride, alphaolefins, polyvinyl butyrate, cellulose acetate, butyrate or cellulose acetate propionate or metallized versions of any of the aforementioned films. Alternately, depending upon the article to be packaged, the web may be made of a metalize foil such as aluminum foil, or the metalized foil may be laminated to the web. Another alternative, especially for use in connection with medical devices, is for one or more webs to be formed of paper and paper products, including paperboard such as containerboard, which includes corrugating medium and linerboard used to make corrugated paper, and boxboard used to make folding cartons. In addition, paper products such as publication grade paper or bleached or unbleached kraft paper, or recycled paper may also be utilized. The above paper products may also be clay-coated to enhance printing of the artwork and text.

In the packaging of medical devices and supplies, it is desirable to provide a peelable but non-resealable closure system. In order to provide a peelable but non-resealable closure for the packaging material, the present invention provides a synthetic-based self seal adhesive system containing no natural rubber. The system is comprised of a transfer adhesive applied to a transfer web and an anchor adhesive applied to an anchor web. Regardless of what is being packaged, it should be noted that the anchor web and transfer web, as described herein, are typically both part of the same substrate and composed of the same material. However, the anchor web and transfer web may be separate substrates and each may be composed of a different material depending upon the particular packaging material desired and the article to be wrapped. In any event, the anchor adhesive and transfer adhesive must have sufficient affinity for each other so that when a sealing pressure appropriate for the marketplace, typically 5 to 20 pounds per linear inch for medical packaging and 60 to 100 pounds per linear inch for confectionery, is applied thereto, the two adhesives bond to each other to form a closure for the packaging material and thus contain or wrap the article inside.

However, for a PNR system in medical packaging, it is essential that the transfer adhesive has more affinity for the anchor adhesive than it does for the substrate of the transfer web. It is also essential that the transfer adhesive does not destroy, pull paper fibers, or if the web is laminated, de-laminate the transfer web substrate when the package is opened. This necessarily implies that it is essential that the anchor adhesive has more affinity for the anchor web and for the transfer adhesive than the transfer adhesive has for the substrate of the transfer web. This is typically measured by percent transfer of the transfer adhesive to the anchor adhesive when peeling in a T-peel configuration. The transfer adhesive, when peeled, must not be resealable to the transfer web.

Thus, the bond formed when the packaging material is closed must be stronger than the bond between the transfer adhesive and the transfer web resulting in the transfer of the transfer adhesive onto the anchor adhesive when the anchor web and transfer web are peeled apart, i.e. the package is opened by a user, to thereby provide a non-resealable package.

In all Peelable self seal systems, the acceptable mode of failure is determined by the market in which the self seal will be sold. Modes of failure include but are not restricted to, cohesive failure, cohesive split, adhesive failure, film or paper destruct, etc.

It is important to note that the self seal adhesives utilized in the present system contains no natural rubber. As used herein, the term “natural rubber” includes all materials made from or containing natural latex. The term “natural/latex” as used herein is defined as a milky fluid that consists of extremely small particles of rubber obtained from plants, principally from the H. brasiliensis (rubber) tree dispersed in an aqueous medium. It contains a variety of naturally occurring substances, including cis-1,4-polyisoprene in a colloidal suspension and plant proteins which are believed to be the primary allergen. Products that contain natural rubber are made using two commonly employed manufacturing processes, namely, the natural rubber latex (NRL) process, and the dry natural rubber (DNR) process. The NRL manufacturing process involves the use of natural latex in a concentrated colloidal suspension. Products are formed from natural rubber latex by dipping, extruding, or coating, and are typically referred to as containing or made of natural rubber latex. Examples of products that may contain natural rubber latex include medical gloves, catheters and tracheotomy tubes. The DNR manufacturing process involves the use of coagulated natural latex in the form of dried or milled sheets. Products are formed from dry natural rubber by compression products typically are referred to as containing or made of dry natural rubber or “crepe” rubber molding, extrusion, or by converting the sheets into a solution for dipping. These. Examples of products that may contain dry natural rubber include syringe plungers, vial stoppers, and injection ports on intravascular tubing.

As mentioned earlier, there are two types of systems that are covered by this invention: PNR and Peelable systems. First described is the PNR system. The preferred transfer adhesive composition of the present invention includes about 30% to about 98% by weight of an elastomer polymer; about 1% to about 60% by weight, of a tackifying resin, about 0% to about 30% by weight, of a suitable conditioning additive, about 0.1% to about 30% by weight, of an antioxidant/stabilizer and about 0% to about 40% by weight of a filler; the remainder are components being comprised of additives, stabilizers, etc.; the components of the composition adding up to 100% by weight.

The preferred anchor adhesive composition of the present invention, includes about 30% to about 95%, by weight, of an elastomer polymer; about 1% to about 60% by weight, of a tackifying resin, about 0% to about 30% by weight, of a suitable conditioning additive, about 0.1% to about 30% by weight, of an antioxidant/stabilizer and about 0% to about 40% by weight of a filler; the remainder are components being comprised of additives, stabilizers, etc.; the components of the composition adding up to 100% by weight.

The elastomers useful in the present compositions, either as a component of the transfer adhesive or the anchor adhesive, include a polymer or copolymer selected from S-I-S (styrene-isoprene-styrene); SBS (styrene-butadiene-styrene); SEBS (styrene-ethylene-butylene-styrene); EVA (ethylene vinyl acetate); APAO (amorphous polyalpha olefin); SBR (styrene-butadiene-rubber); polychloroprene; butyl; and synthetic polyisoprene polymer and copolymer. The most preferred amount of elastomer is from about 45% to 65%.

The tackifying resins which are used in the adhesives of the present invention are those which extend the adhesive properties and improve the specific adhesion of the polymer. The present formulation includes about 1% to about 60% by weight of a tackifying resin. As used herein, the term “tackifying resin” includes:

(a) natural and modified rosin such as, for example, gum rosin, wood rosin, tall-oil rosin, distilled rosin, hydrogenated rosin, dimerized rosin and polymerized resin;

(b) glycerol and pentaerythritol esters of natural and modified rosins, such as, for example, the glycerol ester of pale wood rosin, the glycerol ester of hydrogenated rosin, the glycerol ester of polymerized rosin, the pentaerythritol ester of pale wood rosin, the pentaerythritol ester of hydrogenated rosin, the pentaerythritol ester of tall oil rosin and the phenolic modified pentaerythritol ester of rosin;

(c) polyterpene resins having a softening point, as determined by ASTM method E28-58T, of from about 60° C. to 140° C., the latter polyterpene resins generally resulting from the polymerization of terpene hydrocarbons, such as the monoterpene known as pinene, in the presence of Friedel-Crafts catalysts at moderately low temperatures; also included are the hydrogenated polyterpene resins;

(d) copolymers and terpolymers of natural terpenes, e.g. styrene/terpene, α-methyl styrene/terpene and vinyl toluene/terpene;

(e) phenolic-modified terpene resins such as, for example, the resin product resulting from the condensation, in an acidic medium, of a terpene and a phenol;

(f) aliphatic petroleum hydrocarbon resins having Ring and Ball softening points of from about 60° to 140° C., the latter resins resulting from the polymerization of monomers consisting primarily of olefins and diolefins; also included are the hydrogenated aliphatic petroleum hydrocarbon resins; examples of such commercially available resins based on a C₅-olefin fraction of this type are “Wingtack 95” and “Wingtack 115” tackifying resins sold by Goodyear Tire and Rubber Company;

(g) aromatic petroleum hydrocarbons and the hydrogenated derivatives thereof;

(h) aliphatic/aromatic petroleum derived hydrocarbons and the hydrogenated derivatives thereof.

Mixtures of two or more of the above described tackifying resins may be required for some formulations. Although a range of 1-60% by weight tackifying resin may be used, the preferred range is 10% to 30%. An example of a commercially available tackifying resin which is useful for the present invention includes the resin which is identified commercially by the trade designation Unitac R100L. This resin is a pentacrythritol based tall-oil rosin ester, and is available from Union Camp.

Commercially available polymerized rosins may be secured from Arizona Chemical Company under the trade designations “Sylvatac 295, RX, R85, 95, and 140,” respectively. Additionally, Hercules, Inc. produces a suitable polymerized rosin under the trade designation “PolyPale Resin.” Commercially suitable partially hydrogenated rosins may be secured from Hercules, Inc. under the trade designations “Foral AX” and “Stabelite.” Commercially suitable terpene phenolics may be secured from the Arizona Chemical Company under the trade designations “Nirez V2040” and “V2150,” respectively. Finally, partial ester of dibasic modified tall oil rosins may be secured from Arizona Chemical Company under the trade designation “Sylvatec 203,” and “Beckacite 4901.” Most preferred for this invention is that the tackifying resins are dispersions, emulsions, or solutions in water.

The present invention includes a stabilizer or antioxidant in an amount of from about 0.1% to 30% by weight, but preferably from about 5.0% to 20%. The stabilizers which are useful in the self seal adhesive composition of the present invention are incorporated to help protect the polymers noted above, and thereby the total adhesive system, from the effects of thermal and oxidative degradation which normally occurs during the application of the adhesive as well as in the ordinary exposure of the final product to the ambient environment and sterilization procedures. Such degradation is usually manifested by a deterioration in the appearance, physical properties and performance characteristics of the adhesive. Among the preferred antioxidants are Butyl Zimate, a zinc dibutyldithiocarbamate, and Irganox 1010, a tetrakis(methylene(3,5-di-teri-butyl-4-hydroxyhydrocinnnamate))methane manufactured by Ciba-Geigy. Among the applicable stabilizers are high molecular weight hindered phenols and multifunctional phenols, such as sulfur and phosphorus-containing phenols. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus providing the phenolic compound with its stabilizing properties. Representative hindered phenols include:

1,3,5-trimethyl-2,4,6-tris(3-5-di-tert-butyl-4-hydroxbenzyl) benzene;

pentaerythritol tetrakis-3(3,5-di-tert-butyl-4-hydroxyphenyl) propionate;

n-octadecyl-3(3,5-ditert-butyl-4-hydroxyphenyl) propionate;

4,4′-methylenebis(4-methyl-6-tert butylphenol);

4,4′-thiobis(6-tert-butyl-o-cresol);

2,6-di-tert-butylphenol;

6-(4-hydroxyphenoxy)-2,4-bis(n-ocytlthio)-1,3,5-triazine;

2,4,6-tris(4-hydroxy-3,5-di-tert-butyl-phenoxy)-1,3,5-triazine; di-n-octadecyl-3,5-di-tert-butyl-4-hydroxybenzylphosphonate;

2-(n-octylthio)ethyl-3,5-di-tert-butyl-4-hydroxybenzoate; and

sorbitol hexa-(3,3,5-di-tert-butyl-4-hydroxy-phenyl) propionate.

Preferred as a stabilizer is pentaerythritol tetrakis-3(3,5-di-tert-butyl-4-hydroxyphenol) propionate. Most preferred are the carbamates, such as Butyl Zimate, and various other sulfur containing compounds, etc. Most preferred for this invention is that the antioxidants are dispersions, emulsions, or solutions in water.

The performance of these stabilizers may be further enhanced by utilizing, in conjunction therewith; (1) synergists such as, for example, as thiodipropionate esters and phosphites; and (2) chelating agents and metal deactivators as, for example, ethylenediaminetetraacetic acid, salts thereof, and disalicylalpropylenedimine.

The adhesive composition useful in the method of the present invention may be formulated using any of the techniques known in the art. A representative example of the prior art procedure involves placing the ingredients one by one into a stainless steel mixing vessel, while providing enough agitation to ensure proper and effective mixing of the ingredients. After all the ingredients have been added, the adhesive batch is adjusted to meet its critical physical parameters.

Optional conditioning additives may be incorporated into the adhesive composition in order to modify particular physical properties. These additives may include colorants, such as titanium dioxide, defoamers, sequestrants, deionized water, preservatives, biocides, anti-blocking agents, anti-cling agents, pH adjusters, surfactants and other commonly known and used additives. As noted above, such additives can be present in amounts ranging from 0% to about 30% by weight.

Fillers may also be incorporated into the adhesive composition in amounts ranging from 0% to 40% by weight, preferably 0% to 10% by weight. These are inert in the formulation, and are typically added as an anti-blocking agent. Fillers may include hydrated alumnina (Al₂O₃—3H₂O), silicates such as magnesium silicates, aluminum silicate, sodium silicate, potassium silicate and the like, mica, calcium carbonate (CaCO₃) and silica. Other commonly employed fillers may also be used as long as they do not materially alter the function of the remaining ingredients in the formulation.

As previously noted, the system may also include an anchor primer coating applied as a thin film on the interior surface of the anchor web to enhance adhesion of the anchor adhesive to the anchor web. The anchor primer coating comprises about 2 to 99.9% of a polymer or combination of polymers, selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers. The anchor primer coating preferably comprises 90% by weight of a SBR.

The system may also include a transfer primer coating applied as a thin film on the interior surface of the transfer web to decrease adhesion of the transfer adhesive to the transfer web. The transfer primer coating preferably comprises about 5 to 99.9% by weight of a high molecular weight (i.e. molecular weight greater than 40,000) polyethylene polymer or copolymer. However, the transfer primer coating may be a SIS, SBS, SEBS, SBR, acrylics, silicone, a PVAc (polyvinyl acetate), an EVA (ethylene-vinyl-acetate), PE (polyethylene), PP (polypropylene), EAA (ethylene acrylic acid), EMAA (ethylene methacrylic acid), EEA (ethylene-ethyl acrylate), EMAC (ethylene-methyl acrylate), EVOH (ethylene-vinyl alcohol), or any of these blended with a synthetic elastomer as previously defined herein, and/or other materials to enhance release or stability.

### EXAMPLE 1

A transfer adhesive having the following composition was prepared, wherein all percentages are by weight.

| Amount | | % | Name | Description | Vendor |
|---|---|---|---|---|---|
| 497.5 | LB | 9.9 | | Water | |
| 939.5 | LB | 18.7 | Tacolyn 1100 | Resin | Hercules, Inc. |
| 62.0 | LB | 1.2 | Colloids 999 | Defoamer | Rhone-Poulenc, Inc. |
| 37.6 | LB | .7 | Dee Fo 97-2 | Defoamer | Ultra Additives, Inc. |
| 17.0 | LB | .3 | Tek-38 Ad | Preservative | Calgon Corp. |
| 5.0 | LB | .1 | Dow Versene | Stabilizer | Chemcentral |
| | | | 100 | | Milwaukee |
| 3158.5 | LB | 62.8 | Prinlin B7137 | SIS | Pierce and Stevens |
| | | | Al Dispers | Elastomer | |
| 63.0 | LB | 1.3 | Bostex 556A | Antioxidant | Akron Dispersions, |
| | | | | | Inc. |
| 252.5 | LB | 5.0 | PHX 8195 | Antioxidant | P-H-X, Inc. |

### EXAMPLE 2

An anchor adhesive having the following composition was prepared, wherein all percentages are by weight.

| Amount | | % | Name | Description | Vendor |
|---|---|---|---|---|---|
| 431.0 | LB | 8.6 | | Water | |
| 1260.0 | LB | 25.1 | Tacolyn 1100 | Resin | Hercules, Inc. |
| 208.0 | LB | 4.1 | Hydrad 10 | Filler (Al₂O₃— | J. M. Huber |
| | | | Hydrated | 3H₂O | |
| | | | Aluminum | | |
| 60.5 | LB | 1.2 | Colloids 999 | Defoamer | Rhone-Poulenc, |
| | | | | | Inc. |
| 31.3 | LB | .6 | Dee Fo 97-2 | Defoamer | Ultra Additives, |
| | | | | | Inc. |
| 14.0 | LB | .3 | Tek-38 Ad | Preservative | Calgon Corp. |
| 5.0 | LB | .1 | Dow Versene | Stabilizer | Chemcentral |
| | | | 100 | | Milwaukee |
| 2639.0 | LB | 52.5 | Prinlin B7137 | SIS Elastomer | Pierce and |
| | | | Al Dispers | | Stevens |
| 75.5 | LB | 1.5 | Bostex 556A | Antioxidant | Akron |
| | | | | | Dispersions, Inc. |
| 302.0 | LB | 6.0 | PHX 8195 | Antioxidant | P-H-X, Inc. |

### EXAMPLE 3

A transfer primer coating having the following composition was prepared, wherein all percentages are by weight.

| Ingredient | Description | Amount (lbs.) | % |
|---|---|---|---|
| Water | Water | 1,238.0 | 24.8 |
| Adcote 37R987 | EVA | 3,714.0 | 74.3 |
| Colloids 999 | Defoamer | 15.0 | 0.3 |
| Tek-38AD | Preservative | 0.5 | 0.1 |
| Ammonium Hydroxide | pH adjuster | 29.5 | 0.6 |

The performance of the transfer web, using transfer adhesive EXAMPLE 1 and transfer primer EXAMPLE 3, and the anchor web, using EXAMPLE 2, was compared to commercially available natural rubber based self seal adhesives from Ato Findley, Inc. The products chosen were transfer web adhesive, C1326F01, anchor web adhesive, C1325F01. The substrates used for the comparison were: Transfer Web=30 pound, white sterilizable, bleached, directional paper; Anchor Web=2 mil thick HDPE, corona treated on one side. The transfer web primers and adhesives were coated along the directionality of the paper. The anchor web adhesives were coated on the corona treated side of the HDPE. The results are tabulated below.

TABLE 1

| | Construction | Construction |
|---|---|---|
| Test parameter | C2607-01/C1465-01/ | NA/C1326F01/ |
| | C1466-01 | C1325F01 |
| | Rods Used: 3/7/10 | Rods Used: |
| | | NA/3/7 |
| Average peel strength in | 144 grams | 151 grams |
| grams, sealed with a 10 | | |
| pound rubber roller, 1 pass | | |
| up and 1 pass down | | |
| % Transfer of the transfer | 100 | 100 |
| adhesive/primer to anchor | | |
| adhesive | | |
| Release in grams blocking | Transfer web 25 grams | Transfer web |
| conditions-50 psi/16 | Anchor web 33 grams | 28 grams |
| hours/122 deg. F. | | Anchor web 32 |
| | | grams |

The convention used in the above table in the construction columns are: Transfer Primer/Transfer Adhesive/Anchor Adhesive. The coatings were applied using wire wound rods, identified by numbers. The higher the number, the more material is applied to the substrate. The Rod number identification convention used in the above table in the construction columns are: Transfer Primer/Transfer Adhesive/Anchor Adhesive.

TABLE 2

| | Transfer | Transfer | Anchor | Transfer | Anchor |
|---|---|---|---|---|---|
| Test | Adhesive | Primer | Adhesive | Adhesive | Adhesive |
| Paremeter | Example 1 | Example 3 | Example 2 | C1326F01 | C1325F01 |
| Foam Rise in | 1 | 1 | 4 | 5 | 8 |
| 1/16 inch | | | | | |
| Mechanical | 35 | 50 | 38 | 25 | 30 |
| Stability in | | | | | |
| minutes | | | | | |

It can be seen that the properties of the synthetic based self seal of this invention are generally comparable to or better than those of the natural rubber based adhesives, with acceptable percent foam, seal strength, percent transfer, release, and mechanical stability properties being exhibited.

As mentioned earlier, there are two types of systems that are covered by this invention: PNR and Peelable systems. The following is the second—the Peelable system.

The components of the Peelable system composition are as follows:

### EXAMPLE 4

| Ingredient | % |
|---|---|
| Synthetic Elastomer or Elastomers having a combined Tg lower | 90 to 30 |
| than −60° C. or higher than −40° C. | |
| A polymer emulsion or emulsions having a combined Tg | 0 to 70 |
| between −30° C. and +50° C. | |
| Plasticizer | 0 to 30 |
| pH adjuster(s) | 0 to 5 |
| Stabilizer(s) | 0 to 3 |
| Defoamer(s) | 0 to 3 |
| Anti-blocking/Anti-cling additive(s) | 0 to 20 |
| Other conditioning additives | 0 to 5 |

It is essential that the self seal adhesives come in contact with each other and are sealed with adequate pressure to ensure that a seal is obtained. These pressures range from 5 0.5 to 80 psi and are tested with a dwell time of 0.05 to 10 seconds. It is important to note that the coat weights of these self seal adhesives range from 0.1 to 5.0 pounds dry per 3,000 ft².

It is further important to note that the synthetic elastomer emulsion part of this invention is, but not limited to, either a Styrene Butadiene Rubber or an Acrylic Elastomer. Other elastomers include, but are not limited to, other acrylics, acrylic copolymers, isoprenes such as SIS and synthetic polyisoprene, polybutadienes such as SBS, styrene block copolymers such as SEBS, polychloroprenes, epdms, butyls, ethylene-vinylacetate amorphous polyalpha-olefin, and silicones, and/or combinations of these elastomers.

It is also important to note that the polymer emulsion part of this invention is, but not limited to a carboxylated Vinyl Acetate Ethylene emulsion or a Styrene Acrylate emulsion. Other polymer emulsions include, but are not limited to, acrylates, styrene acrylates, vinyl acetates, vinyl acetate ethylene copolymers, ethylene vinyl acetate copolymers, (high styrene) styrene butadiene rubbers, polyurethane dispersions, polystyrene emulsions, vinyl chloride ethylene emulsions, polyvinyl chloride homopolymer and copolymer emulsions, polyvinylidene chloride homopolymer and copolymer emulsions, polyethylene homopolymer and copolymer emulsions, polypropylene homopolymer and copolymer emulsions, and polyester emulsions, and/or combinations of these polymers.

It is important that the plasticizer be miscible with the polymer emulsion and/or the elastomer emulsion. Plasticizers of this type are: benzoate esters, phthalate esters, sebacate esters, adipate esters, acrylic esters, glycolate esters, citrate esters, aromatic oils, napthenic oils, paraffinic oils, oligomeric polyesters, lactates, liquid rosin esters, glycerates, and other monomeric, oligomeric or polymeric esters, or oils.

It is desirable that the plasticizer be preferably miscible with the polymer emulsion and be alkali soluble. Plasticizers of this type are: Carboset 515 supplied by BF Goodrich Specialty Chemicals, low molecular weight acrylic or acrylic copolymers having acid numbers between 25 and 250, low molecular weight olefin copolymers having acid numbers between 25 and 250, liquid rosin esters having acid numbers between 25 and 250, and other low molecular weight liquid polymers having acid numbers between 25 and 250.

In a peelable self-seal adhesive system, the transfer adhesive and anchor adhesive may have substantially the same formulation, and be preferably comprised of:

about 70 to 85% by weight of a styrene-butadiene elastomer emulsion;

about 10 to 20% by weight of a styrene-acrylate polymer emulsion;

about 0.5 to 2% by weight of a plasticizer;

about 0.5 to 2% by weight of antiblocking/anticling additives; and

about 0.1 to 10% by weight of defoamers, pH adjusters, stabilizers, antioxidants and other additives; the components totaling 100% by weight of said adhesive.

It is important that the self seal system processes in the customer's equipment and releases from the back side of the roll when wound on a roll core.

Examples of the Peelable system are as follows:

### EXAMPLE 5

| Material | Amount in % | Description |
|---|---|---|
| Rovene 4020 | 75.4 | Styrene Butadiene Rubber |
| | | Tg = −30 deg. C. |
| Hycar 26288 | 16.8 | Styrene Acrylate polymer |
| | | Tg = +20 deg. C. |
| Carboset 515 | 1.2 | Alkali soluble Acrylic |
| | | Plasticizer Tg = −14 deg. C. |
| Lo-Vel 29 | 1 | Anti-blocking additive |
| Michemlube 156F | 0.4 | Anti-blocking additive |
| Dee-Fo 97-2 | 0.2 | DeFoamer |
| Aqueous Ammonia | 0.6 | PH Adjuster |
| (Ammonium Hydroxide) | | |
| Water | 4.4 | Viscosity Adjusting Additive |

### EXAMPLE 6

| Material | Amount in % | Description |
|---|---|---|
| Carbotac XPD-1814 | 65.3 | Acrylic Rubber |
| | | Tg = −30 deg. C. |
| Hycar 26288 | 27.4 | Styrene Acrylate Polymer |
| | | Tg = +20 deg. C. |
| Hystretch V-43 FDA | 5.3 | Acrylic Rubber |
| | | Tg = −43 deg. C. |
| Lo-Vel 29 | 1 | Anti-blocking Additive |
| Dee Fo 97-2 | 0.6 | DeFoamer |
| Aqueous Ammonia | 0.4 | PH Adjuster |
| (Ammonium Hydroxide) | | |

To assess the utility of the self seal adhesives in various packaging applications, the synthetic adhesives disclosed below, were applied to a representative commercially available substrate film at a coat weight of 2.0 pounds per 3,000 ft² ream, +/−0.2 pounds per 3,000 ft² ream, using a #5 wire wound rod. All samples were sealed on a TMI^{R} SuperSealer_{™} Model #75-10, set at 0.5 second dwell, room temperature, and 80 psi over a 1 by 4 inch sample. All samples were peeled in a “T-Peel” mode at 12 inches per minute.

In Table 3 below, example 5 and example 6 are compared to product C1380-01, natural latex containing self seal manufactured by Ato Findley, Inc.

All products were coated onto “MLB 50 gage” polypropylene film manufactured by AET (Advanced Extrusion Technologies, Inc.), and blocked to “RLS-60 gage” polypropylene film manufactured by AET (Advanced Extrusion Technologies, Inc.).

All products were blocked as coated MLB to RLS in a Kohler Block Tester for 16 hours, at 100 psi at either RT (Room Temperature) or 122 deg. F. The samples were then removed from the block tester and allowed to equilibrate for 1 hour. Then the samples were evaluated for release in an I-Mass_{™} Peel tester at 12 inches per minute.

In evaluating acceptable results, the following guidelines were used:

Minimum Peel Strength: approximately equal to C1380-01

Peak Peel Strength: > or=to 300 grams

Release Value after aging at RT: <100 grams

Release Value after aging at 122 deg. F: <100 grams

TABLE 3

| Test Parameter | Example 5 | Example 6 | C1380-01 |
|---|---|---|---|
| Minimum Peel Strength in grams | 280 | 233 | 240 |
| Peak Peel Strength in grams | 425 | 340 | 380 |
| Release Value, after aging at RT | 28 | 26 | 22 |
| for 16 hours at 100 psi, in grams | | | |
| Release Value, after aging at 122 | 45 | 18 | 60 |
| deg. F. for 16 hours at 100 psi, in | | | |
| grams | | | |

As can be seen both examples 5 and 6 meet or exceed the performance of natural latex containing self seals. As stated earlier, the application of synthetic self seals are not limited to the substrate combination disclosed herein.

We claim:

1. A water based non-natural rubber containing self seal adhesive system for bonding an anchor web to a transfer web to form a package to contain an article, said adhesive system comprising:
a transfer adhesive to be coated on a surface of the transfer web, said transfer adhesive comprises:
about 30 to 98% by weight of an elastomer;
about 1 to 60% by weight of a tackifying resin;
about 0.1 to 30% by weight of an antioxidant;
about 0 to 40% by weight of an inert filler;
about 0 to 30% by weight of a conditioning additive; and
the components totaling 100% by weight of said transfer adhesive; and
an anchor adhesive to be coated on a surface of the anchor web, said anchor adhesive comprises:
about 30 to 95% by weight of an elastomer;
about 1 to 60% by weight of a tackifying resin;
about 0.1 to 30% by weight of an antioxidant;
about 0 to 40% by weight of an inert filler;
about 0 to 30% by weight of a conditioning additive; and
the components totaling 100% by weight of said anchor adhesive.

2. The adhesive system of claim 1, wherein said adhesive system is a peelable, non-reseable self seal system and said transfer adhesive comprises:
about 55 to 65% by weight of a styrene-isoprene-styrene elastomer emulsion;
about 10 to 20% by weight of a modified rosin ester tackifying resin emulsion;
about 7 to 17% by weight of antioxidant dispersions; and
about 7 to 17% by weight of filler and conditioning additives.

3. The adhesive system of claim 1, wherein said adhesive system is a peelable, non-resealable self seal system and said anchor adhesive comprises:
about 45 to 55% by weight of a styrene-isoprene-styrene elastomer emulsion;
about 20 to 30% by weight of a modified rosin ester tackifying resin emulsion;
about 7 to 18% by weight of antioxidant dispersions; and
about 7 to 17% by weight of filler and conditioning additives.

4. The adhesive system of claim 1, further including an anchor primer coating on the surface of said anchor web to enhance adhesion of said anchor adhesive to said anchor web.

5. The adhesive system of claim 4 wherein said anchor primer coating comprises about 2 to 99.9% of a polymer or combination of polymers, selected from the group consisting of: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers.

6. The adhesive system of claim 1, further including a transfer primer coating on the interior surface of said transfer web to decrease adhesion of the transfer adhesive to said transfer web.

7. The adhesive system of claim 6 wherein said transfer primer coating comprises about 5 to 99% by weight of a polymer selected from the group consisting of: a high molecular weight polyethylene polymer or ethylene copolymer, SIS, SBS, SEBS, SBR, acrylics, and silicones.

8. The adhesive system of claim 1 wherein said elastomer is a polymer or copolymer selected from the group consisting of styrene-isoprene-styrene, styrene-butadiene-styrene, styrene-ethylene-butylene-styrene, ethylene-vinylacetate, amorphous polyalpha-olefin, styrene-butadiene rubber, butyl, polychloroprene, and synthetic polyisoprene.

9. The adhesive system of claim 1 wherein said tackifying resin is selected from the group consisting of polyterpene resins, hydrogenated polyterpene resins, copolymers of natural terpenes, phenolic modified polyterpene resins, aliphatic hydrocarbon resins, hydrogenated aliphatic hydrocarbon resins, aromatic hydrocarbon resins, hydrogenated aromatic hydrocarbon resins, rosins, hydrogenated rosins, wood rosin esters, hydrogenated wood rosin esters, tall oil rosin esters, hydrogenated tall oil rosin esters, and mixtures thereof.

10. The adhesive system of claim 1, wherein said adhesive system is a peeable self seal system and said transfer adhesive and said anchor adhesive have substantially the same formulation and are comprised of:
about 30% to 90% by weight of an elastomer or elastomers having a combined Tg lower than −60° C. or higher than −40° C.;
about 1% to 70% by weight of a polymer emulsion or emulsions having a combined Tg between about −30° C. and +50° C.;
about 0 to 30% of a plasticizer; and
about 0 to 28% of one or more conditioning additive;
the components totaling 100% by weight of said adhesive.

11. The adhesive system of claim 10 wherein said elastomer is a polymer or copolymer selected from the group consisting of styrene-isoprene-styrene, styrene-butadiene-styrene, styrene-ethylene-butylene-styrene, ethylene-vinylacetate, amorphous polyalpha-olefin, styrene-butadiene rubber, acrylics, acrylic copolymers, epdms, butyl, polybutadienes, polychloroprene, silicones, synthetic polyisoprene and/or combinations of these elastomers

12. The adhesive system of claim 10 wherein said polymer emulsion is selected from the group consisting of: carboxylated vinyl acetate ethylene emulsion, styrene acrylate emulsion and acrylates, styrene acrylates, vinyl acetates, vinyl acetate ethylene copolymers, ethylene vinyl acetate copolymers, (high styrene) styrene butadiene rubbers, polyurethane dispersions, polystyrene emulsions, vinyl chloride ethylene emulsions, polyvinyl chloride homopolymers and copolymers emulsions, polyvinylidene chloride homopolymers and copolymer emulsions, polyethylene homopolymer and copolymer emulsions, polypropylene homopolymer and copolymer emulsions, and polyester emulsions, and/or mixtures thereof.

13. The adhesive system of claim 10 wherein said transfer and anchor adhesives are comprised of:
about 70 to 85% by weight of a styrene-butadiene elastomer emulsion;
about 10 to 20% by weight of a styrene-acrylate polymer emulsion;
about 0.5 to 2% by weight of a plasticizer;
about 0.5 to 2% by weight of antiblocking/anticling additives;
about 0.1 to 10% by weight of other conditioning additives; the components totaling 100% by weight of said adhesive.

14. The adhesive system of claim 10 further including a primer coating on the surface of said anchor web to enhance adhesion of said anchor adhesive to said anchor web.

15. The adhesive system of claim 14 wherein said anchor primer coating comprises about 2 to 99.9% of a polymer or combination of polymers, selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers.

16. The adhesive system of claim 10 further including a primer coating on the surface of said transfer web to enhance adhesion of said transfer adhesive to said transfer web.

17. The adhesive system of claim 16 wherein said transfer primer coating comprises about 2 to 99.9% of a polymer or combination of polymers, selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers.

18. The adhesive system of claim 1 wherein said transfer and anchor web are each independently selected from a substrate composed of a material selected from the group consisting of paper, polyolefin, polyester, nylon, polyvinylchloride and metalized versions of these substrates as well as metal foil.

19. The adhesive system of claim 1 wherein said transfer adhesive and said anchor adhesive have different formulations, and said transfer web and said anchor web are separate substrates each composed of a different material.

20. The adhesive system of claim 1 wherein said transfer adhesive and said anchor adhesive have substantially the same formulations, and said transfer web and said anchor web are composed of different materials.

21. The adhesive system of claim 1 wherein said transfer adhesive and said anchor adhesive have different formulations, and said transfer web and said anchor web are both part of the same substrate and composed of the same material.

22. The adhesive system of claim 1 wherein said transfer adhesive and said anchor adhesive have substantially the same formulations, and said transfer web and said anchor web are both part of the same substrate and composed of the same material.

23. The adhesive system of claim 1 wherein said conditioning additive is selected from the group consisting of defoamers, biocides, anti-blocking agents, anti-cling agents, colorants, sequestrants, preservatives and surfactants.
